(19) United States
(12) Patent Application Publication
(10) Pub. No.: US 2024/0212068 A1
(43) Pub. Date: Jun. 27, 2024

(54) USING PUBLIC AND PRIVATE AGRICULTURAL KNOWLEDGE GRAPHS TO GENERATE AGRICULTURAL INFERENCES

(71) Applicant: Mineral Earth Sciences LLC, Mountain View, CA (US)

(72) Inventors: Yujing Qian, Mountain View, CA (US); Zhiqiang Yuan, San Jose, CA (US); Yuanyuan Tian, Sunnyvale, CA (US); Gaoxiang Chen, Mountain View, CA (US); Yawen Zhang, Mountain View, CA (US)

(21) Appl. No.: 18/087,448

(22) Filed: Dec. 22, 2022

(51) Int. Cl. G06Q 50/02; G06F 21/62

(52) U.S. Cl. CPC G06Q 50/02; G06F 21/6227

(57) ABSTRACT

Implementations are described herein for leveraging private and public agricultural knowledge graphs to generate agricultural inferences for growers, automatically based on agricultural events and/or on demand. In various implementations, public data source(s) may be identified using a public agricultural knowledge graph. These public source(s) may contain public data usable to respond to an agricultural query seeking agricultural inference(s) about a subject agricultural field managed by an agricultural entity. Public data retrieved from the public data source(s) may be encoded into public embedding(s) and passed to a private computing system controlled by the agricultural entity. The private computing system may identify, using a private agricultural knowledge graph, private data source(s) containing private data that can respond to the agricultural query, and encode that private data into private embedding(s). The public and private embeddings may be processed using machine learning model(s) to generate agricultural inference(s) about the subject agricultural field.

### BACKGROUND

The rise of precision agriculture has enabled growers to manage their crops more efficiently, which increases crop yields and reduces waste, among other things. Autonomous vehicles such as satellites and sensor-equipped robots (ground- and land-based), as well as sensor packages mounted on conventional agricultural vehicles such as tractors, booms, etc., enable growers to gather ever-more-massive sensor data about crops than is practical with human-based sampling. Machine learning (ML) has enabled the growers to extract value from the gathered sensor data in the form of agricultural inferences such as predicted crop yield, classification, detected phenotypic traits, etc.

However, while most growers have significant expertise in agriculture, they may lack expertise in data science. Consequently, growers tend to work with data scientists to implement ML pipelines that facilitate the practice of precision agriculture. However, this paradigm does not scale well to the ever-changing needs of a typical grower. Moreover, growers may be reluctant to expose private and/or sensitive agricultural data, such as historical crop yields, agricultural management practices, etc., to outside entities so that this data can be used as inputs to ML pipelines.

### SUMMARY

Implementations are described herein for leveraging private and public agricultural knowledge graphs to generate agricultural inferences (e.g., predictions, crop maps, recommendations, warnings) for growers, automatically based on agricultural events and/or on demand. More particularly, but not exclusively, techniques are described herein for using the private and public agricultural knowledge graphs to allow agricultural inferences to be generated using ML pipeline(s) based in part on private data, without exposing that private data to untrusted entities.

In various implementations, a method may be implemented using one or more processors and may include: identifying, using a public agricultural knowledge graph, one or more public data sources containing public data that is usable to respond to (e.g., fully or partially resolve) an agricultural query seeking one or more agricultural inferences about a subject agricultural field managed by an agricultural entity; encoding public data retrieved from the one or more public data sources into one or more public embeddings, wherein the encoding is performed using one or more machine learning models; passing the one or more public embeddings to a private computing system controlled by the agricultural entity. The passing may cause the private computing system to: identify, using a private agricultural knowledge graph accessible to the private computing system, one or more private data sources containing private data that is usable to respond to (e.g., fully or partially resolve) the agricultural query; and encode private data retrieved from the one or more private data sources into one or more private embeddings. The one or more public embeddings and one or more private embeddings may be processed using one or more of the machine learning models to generate the one or more agricultural inferences about the subject agricultural field.

In various implementations, the passing may cause the private computing system to process the public and private embeddings using one or more of the machine learning models to generate the one or more agricultural inferences about the subject agricultural field. In various implementations, one or more of the machine learning models may include a transformer network.

In various implementations, the encoding may include generating an aggregate public embedding from a plurality of different public embeddings generated from public data retrieved from a plurality of public data sources; and the passing may include passing the aggregate public embedding to the private computing system controlled by the agricultural entity. In various implementations, the aggregate public embedding may be generated by processing the plurality of different public embeddings using a sequence-to-sequence machine learning model.

In various implementations, the private computing system may include one or more computing devices that collectively provide a private cloud computing environment to the agricultural entity. In various implementations, the private computing system may include one or more edge computing devices operated by the agricultural entity.

In various implementations, the public data includes data about one or more other agricultural fields that are proximate to the subject agricultural field. In various implementations, the public data includes satellite imagery that depicts the subject agricultural field. In some such implementations, the public data includes inferences generated from processing the satellite imagery using one or more machine learning models.

In another aspect, a method may be implemented using one or more processors of a private computing system controlled by an agricultural entity, and may include: causing an agricultural query seeking one or more agricultural inferences about a subject agricultural field managed by the agricultural entity to be processed using a public agricultural knowledge graph; receiving one or more public embeddings generated using the public agricultural graph based on the agricultural query, wherein the one or more public embeddings encode public data, retrieved from one or more public data sources, that is usable to respond to (e.g., fully or partially resolve) the agricultural query; identifying, using a private agricultural knowledge graph accessible to the private computing system, one or more private data sources containing private data that is usable to respond to (e.g., fully or partially resolve) the agricultural query; encoding private data retrieved from the one or more private data sources into one or more private embeddings; and processing the one or more public embeddings and one or more private embeddings using one or more machine learning models to generate the one or more agricultural inferences about the subject agricultural field.

In various implementations, one or more of the machine learning models may be a transformer network. In various implementations, the private computing system may include one or more computing devices that collectively provide a private cloud computing environment to the agricultural entity. In various implementations, the private computing system may include one or more edge computing devices operated by the agricultural entity.

In various implementations, the processing may include processing the one or more public embeddings and the one or more private embeddings using a sequence-to-sequence machine learning model. In various implementations, one or more of the private data sources may include one or more documents accessible to the agricultural entity. In various implementations, one or more of the private data sources may include a database of agricultural operations performed in the subject agricultural field. In various implementations, one or more of the private data sources may include one or more historical crop yields of the subject agricultural field.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in transitory and/or non-transitory computer-readable memory, and where the instructions are configured to enable performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be employed in accordance with various implementations.

FIG. 2 schematically depicts an example agricultural knowledge graph, in accordance with various implementations.

FIG. 3 schematically depicts an example of how selected aspects of the present disclosure may be implemented, in accordance with various implementations.

FIG. 4 is a flowchart of an example method in accordance with various implementations described herein.

FIG. 5 is a flowchart of an example method in accordance with various implementations described herein.

FIG. 6 schematically depicts an example architecture of a computer system.

### DETAILED DESCRIPTION

Implementations are described herein for leveraging private and public agricultural knowledge graphs to generate agricultural inferences (e.g., predictions, crop maps, recommendations, warnings) for growers, automatically based on agricultural events and/or on demand. More particularly, but not exclusively, techniques are described herein for using the private and public agricultural knowledge graphs to allow agricultural inferences to be generated using ML pipeline(s) based in part on private data, without exposing that private data to untrusted entities.

In various implementations, the private and/or public agricultural knowledge graphs may include nodes representing entities and edges representing relationships between those entities. In the agricultural context, entities may include abstract concepts such as types of crops, types of disease or pests, types of agricultural equipment/materials, and so forth. Entities may also include concrete concepts such as specific people, locations (e.g., individual fields or farms), historical crop yields, historical agricultural management practices, and/or objects. In some implementations, the private and/or public agricultural knowledge graphs may be stored in graph database(s).

In various implementations, the agricultural knowledge graphs may be used to identify data source(s) containing data that is usable to resolve an agricultural query. An “agricultural query” may be a command, request, intent (e.g., with parameters), or any other communication or payload that seeks (e.g., triggers generation of) one or more agricultural inferences about a subject agricultural field managed by an agricultural entity. Agricultural knowledge graphs (public and/or private) may be queried using these agricultural queries to cause edges to be traversed to identify pertinent nodes. Nodes and/or edges of the agricultural knowledge graphs may provide access to various types of public and/or private data that may be input to ML processing pipeline(s), and/or may provide access to ML models used as part of these ML processing pipeline(s).

In some implementations, an agricultural query may be generated automatically in response to an agricultural event. Some agricultural events may impact or influence individual agricultural fields directly. For example, weather events such as rainfall, hurricanes, frost, drought, extreme heat, flooding (natural or caused by man), etc., may impact the growth or health of crops directly. Pest or weed infestation likewise may impact crops in fields in which those pests or weeds are detected. Crop management events such as chemical application, irrigation, tillage, etc. may also directly impact crops in those fields being managed. Alternatively, agricultural events occurring in one field may predict agricultural event(s) other field(s). For example, detection of pests in one field may predict a likely future infestation of the same type of pests in nearby field(s), assuming no action is taken and/or crops grown in the nearby field(s) are vulnerable to those pests. Similarly, application of a particular pesticide to one field may predict potential future infestation of nearby field(s) by the pest targeted by that pesticide, again assuming no action is taken and/or vulnerable crops.

Additionally or alternatively, an agricultural query may be generated on demand by an agricultural entity, e.g., using typed and/or spoken natural language input. For example, a grower may utter the request, “give me a P & K removal map for my northwest field” (P&K stands for phosphorus (P) and potassium (K)). This request may be processed, e.g., using various natural language processing techniques, to identify an intent (P&K removal map) and parameter(s) (an identifier corresponding to the grower's northwest field) for fulfilling the intent in association with the subject agricultural field.

In various implementations, the intent/parameter(s) may be provided to an agricultural inference system. In some implementations, the agricultural inference system may identify, e.g., based on public and private agricultural knowledge graphs, one or more ML processing pipelines based on the intent. A ML processing pipeline may include, for instance, one or more trained ML models connected by logic (e.g., glue code). The identified ML processing pipeline(s) in turn may be used to identify a plurality of different types of data that are usable to resolve the intent. For example, ML processing pipelines may be designed specifically to operate on particular types of input data. In some cases, individual ML models used in the ML processing pipelines may be trained using specific types of data. However, this is not required. Some ML processing pipelines may be capable of processing multiple modalities of input data by using multi-modal ML models, such as transformer networks. Transformer networks may be able to operate on sequences of data, such as sequences of private and public semantically rich embeddings. These sequences need not be uniform in length-it may be the case that the transformer network can generate a somewhat less than fully accurate, but still useful, prediction based on less than all possible data sources.

The public and/or private agricultural knowledge graphs may then be used to identify data sources containing the different types of data that are usable to resolve the intent (e.g., the types of data used by the applicable ML processing pipeline). For example, to make a crop yield prediction, different types of public and/or private data such as precipitation over time, applied fertilizer in the particular field, tillage practice, crop varietal, crop rotation, presence of pests, regional climate, etc., may be useful.

The data sources that include data usable to resolve the intent may include public data sources and private data sources. The public data sources may be accessible via the public agricultural knowledge graph and may include, for instance, weather/climate data, satellite imagery, “remote sensing” data such as inferences generated from satellite imagery using machine learning models, agricultural regulations and/or restrictions that are applicable in the region that includes the subject agricultural field, etc. The public data sources may also include data about individual fields where available. For example, other growers that manage nearby fields may publish data about their fields, such as historical crop yields, agricultural management practices, pest/disease infestation events, etc.

The private data sources may be accessible via the private agricultural knowledge graph controlled by the agricultural entity (e.g., grower) that manages the agricultural field(s) in question. The private data sources may include, for instance, databases, spreadsheets, or other data storage locations that are hosted on private computing system(s) under the agricultural entity's control. An “agricultural entity” may be a person or organization (e.g., company, co-op, partnership) that controls, farms, maintains, and/or otherwise manages agricultural field(s). As will be explained below, a “private computing system” may be a computing system controlled by an agricultural entity that is implemented at the edge and/or within a private cloud infrastructure. Types of data that are often deemed private (and protected by agricultural entities) may include, for instance, historical crop yields for particular agricultural fields, agricultural management practices (e.g., irrigation, tillage, chemical application, etc.) implemented in particular fields, sensor readings in particular fields (e.g., soil samples, pH levels), and so forth.

In some implementations, the public and private knowledge graphs may be used together as follows. Public data may be retrieved, e.g., by the agricultural inference system, from one or more public data sources that are accessible via the public agricultural knowledge graph. This public data may be encoded, e.g., using one or more machine learning models (e.g., a transformer network), into one or more public embeddings, e.g., continuous vector embeddings. In some cases, multiple public embeddings may be encoded from multiple different public data sources, and these multiple public embeddings may be used to generate an aggregate embedding that is semantically richer than the individual public embeddings used to create it. For example, the public embeddings may be combined into the aggregate embedding via concatenation and/or averaging, or may be processed as a sequence (e.g., using a sequence-to-sequence ML model such as a transformer network) to generate the aggregate embedding.

In some implementations, the one or more public embeddings (e.g., the aggregate embedding) may be passed, e.g., by a public agricultural inference system, to a private computing system controlled by the agricultural entity. This private computing system may take various forms. In some implementations, the private computing system may include one or more computing devices that collectively provide a private cloud computing environment to the agricultural entity. Alternatively or additionally, the private computing system may include one or more edge computing devices operated by the agricultural entity, e.g., on premise or nearby.

The private computing system may be configured to use the private agricultural knowledge graph accessible to the private computing system to identify private data source(s) containing private data that is usable to partially resolve the intent of the agricultural query. For example, to predict a crop yield for the subject field, private data such as historical crop yields, fertilizer composition, tillage practices, etc., may be obtained from one or more private data sources (e.g., local databases, logs, local sensor data, etc.). In various implementations, private data retrieved from the one or more private data sources may be encoded into one or more private embeddings, similar to the public embeddings described previously. In some cases, machine learning model(s) that mirror those used to encode the public embeddings may be used to encode the private embeddings.

In various implementations, the one or more public embeddings and one or more private embeddings may be processed, e.g., by the private computing system using one or more machine learning models (e.g., a transformer network trained on myriad agricultural data). Based on this processing, agricultural inference(s) about the subject agricultural field may be generated. By performing the last leg of processing at the private computing system, there is no need to provide private data to a remote computing system, such as the public agricultural inference system mentioned previously.

In some implementations, rather than performing the last leg of processing using the private computing system, the process may work in reverse. For example, all or part of a grower's private agricultural knowledge graph (e.g., the portion relevant to a particular field) may be processed to generate a semantically rich field-level embedding that encodes not only the disparate data points contained in the private agricultural knowledge graph, but the relationships between those data points. For example, pieces of metadata of the private agricultural knowledge graph may be tokenized and used to generate the semantically rich field-level embedding, which may then be provided to the agricultural inference system. The agricultural inference system may process this semantically rich field-level embedding along with one or more public embeddings (e.g., an aggregate public embedding described previously) to generate inferences about the subject agricultural field. In some implementations, each node of the private agricultural knowledge graph may be tokenized (e.g., encoded as an embedding) using, for instance, a transformer network. Then, a graph of these tokens may be processed, e.g., using a graph neural network (GNN) or variation thereof, to generate the semantically rich field-level embedding mentioned previously.

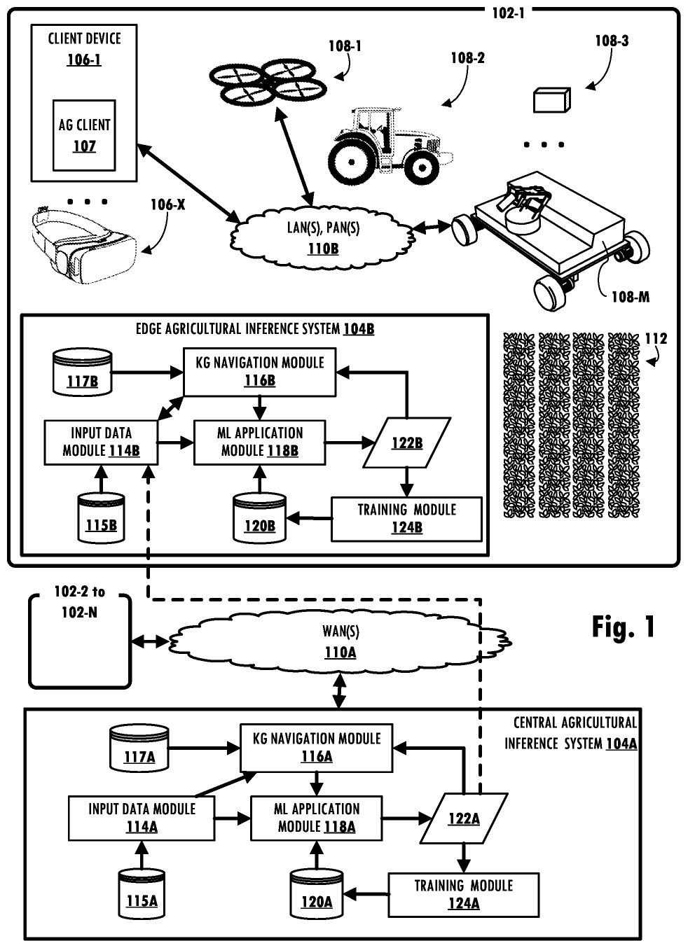

FIG. 1 schematically illustrates one example environment in which one or more selected aspects of the present disclosure may be implemented, in accordance with various implementations. The example environment depicted in FIG. 1 relates to the agriculture domain, which is a beneficial domain for implementing selected aspects of the present disclosure. However, this is not meant to be limiting. Techniques described here may be useful in any domain in which private or sensitive data is applied to machine learning models to generate inferences.

The environment of FIG. 1 includes a plurality of edge sites 102-1 to 102-N (e.g., farms, fields, plots, or other areas in which crops are grown) and a central agricultural inference system 104A. Additionally, one or more of the edge sites 102, including at least edge site 102-1, includes an edge agricultural inference system 104B, a plurality of client devices 106-1 to 106-X, human-controlled and/or autonomous farm equipment 108-1 to 108-M, and one or more fields 112 that are used to grow one or more crops. Field(s) 112 may be used to grow various types of crops that may produce plant parts of economic and/or nutritional interest. These crops may include but are not limited to everbearing crops such as strawberries, tomato plants, or any other everbearing or non-everbearing crops, such as soybeans, corn, lettuce, spinach, beans, cherries, nuts, cereal grains, berries, grapes, sugar beets, and so forth.

One edge site 102-1 is depicted in detail in FIG. 1 for illustrative purposes. However, as demonstrated by additional edge sites 102-2 to 102-N, there may be any number of edge sites 102 corresponding to any number of farms, fields, or other areas in which crops are grown, and in which large-scale agricultural tasks such as harvesting, weed remediation, fertilizer application, herbicide application, planting, tilling, etc. are performed. Each edge site 102 may include the same or similar components as those depicted in FIG. 1 as part of edge site 102-1.

In various implementations, components of edge sites 102-1 to 102-N, central agricultural inference system 104A, and edge agricultural inference system 104B, collectively form a distributed computing network in which edge nodes (e.g., client device 106, edge agricultural inference system 104B, farm equipment 108) are in network communication with central agricultural inference system 104A via one or more networks, such as one or more wide area networks (“WANs”) 110A. Components within edge site 102-1, by contrast, may be relatively close to each other (e.g., part of the same farm or plurality of fields in a general area), and may be in communication with each other via one or more local area networks (“LANs”, e.g., Wi-Fi, Ethernet, various mesh networks) and/or personal area networks (“PANs”, e.g., Bluetooth), indicated generally at 110B.

An individual (which in the current context may also be referred to as a “user”) may operate a client device 106 to interact with other components depicted in FIG. 1. Each client device 106 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) 106-X that provides an AR or VR immersive computing experience, a “smart” watch, and so forth. Additional and/or alternative client devices may be provided.

Central agricultural inference system 104A and edge agricultural inference system 104B (collectively referred to herein as “agricultural inference system 104”) comprise an example of a distributed computing network for which techniques described herein may be particularly beneficial. Each of client devices 106, agricultural inference system 104, and/or farm equipment 108 may include one or more memories for storage of data and software applications, one or more processors for accessing data and executing applications, and other components that facilitate communication over a network. The computational operations performed by client device 106, farm equipment 108, and/or agricultural inference system 104 may be distributed across multiple computer systems.

Each client device 106 and some farm equipment 108 may operate a variety of different applications that may be used, for instance, to obtain and/or analyze various agricultural inferences (real time and delayed) generated using machine learning models that are created as described herein. For example, a first client device 106-1 operates an agricultural (AG) client 107 (e.g., which may be standalone or part of another application, such as part of a web browser) that may allow the user to, among other things, view various inferences made about field 112 using machine learning models described herein. Another client device 106-X may take the form of an HMD that is configured to render 2D and/or 3D data to a wearer as part of a VR immersive computing experience. For example, the wearer of client device 106-X may be presented with 3D point clouds (e.g., generated using MT-DP models described herein) representing various aspects of objects of interest, such as fruit/vegetables of crops, weeds, crop yield predictions, etc. The wearer may interact with the presented data, e.g., using HMD input techniques such as gaze directions, blinks, etc.

Individual pieces of farm equipment 108-1 to 108-M may take various forms. Some farm equipment 108 may be operated at least partially autonomously, and may include, for instance, an unmanned aerial vehicle 108-1 that captures sensor data such as digital images from overhead field(s) 112. Other autonomous farm equipment may include a robot (not depicted) that is propelled along a wire, track, rail or other similar component that passes over and/or between crops, a wheeled robot 108-M, or any other form of robot capable of being propelled or propelling itself past crops of interest. In some implementations, different autonomous farm equipment may have different roles, e.g., depending on their capabilities. For example, in some implementations, one or more robots may be designed to capture data, other robots may be designed to manipulate plants or perform physical agricultural tasks, and/or other robots may do both. Other farm equipment, such as a tractor 108-2, may be autonomous, semi-autonomous, and/or human driven. Any of farm equipment 108 may include various types of sensors, such as vision sensors (e.g., 2D digital cameras, 3D cameras, 2.5D cameras, infrared cameras), inertial measurement unit (“IMU”) sensors, Global Positioning System (“GPS”) sensors, X-ray sensors, moisture sensors, barometers (for local weather information), photodiodes (e.g., for sunlight), thermometers, etc.

In some implementations, farm equipment 108 may take the form of one or more modular edge computing nodes 108-3. An edge computing node 108-3 may be a modular and/or portable data processing device and/or sensor package that may be carried through an agricultural field 112, e.g., by being mounted on another piece of farm equipment (e.g., on a boom affixed to tractor 108-2 or to a truck) that is driven through field 112 and/or by being carried by agricultural personnel. Edge computing node 108-3 may include logic such as processor(s), application-specific integrated circuits (ASICs), field-programmable gate arrays (FPGA), Tensor Processing Units (TPUs), etc., configured with selected aspects of the present disclosure to capture and/or process various types of sensor and other data to make agricultural inferences using ML models described herein.

In some examples, one or more of the components depicted as part of edge agricultural inference system 104B may be implemented in whole or in part on a single edge computing node 108-3. across multiple edge computing nodes 108-3, and/or across other computing devices, such as client device(s) 106. Thus, when operations are described herein as being performed by/at edge agricultural inference system 104B, or as being performed “locally” or “in situ,” it should be understood that those operations may be performed by one or more edge computing nodes 108-3, and/or may be performed by one or more other computing devices at the edge 102, such as on client device(s) 106.

In various implementations, edge agricultural inference system 104B may include an edge input data module 114B, an edge knowledge graph (KG) navigation module 116B, an edge ML application module 118B, and in some cases, edge training module 124B. Edge agricultural inference system 104B may also include one or more edge databases 115B, 117B, 120B for storing various data used by and/or generated by modules 114B, 116B, 118B, and 124B, such as vision and/or other sensor data gathered by farm equipment 108-1 to 108-M, agricultural inferences, machine learning models that applied to data as described herein, and so forth. In some implementations one or more of modules 114B, 116B, 118B, and/or 124B may be omitted, combined, and/or implemented in a component that is separate from edge agricultural inference system 104B. In various implementations, central agricultural inference system 104A may include the same or similar components as edge agricultural inference system 104B (except with the “B” suffix replaced with an “A” suffix).

In various implementations, central agricultural inference system 104A may be implemented across one or more computing systems that may be referred to as the “cloud.” Central agricultural inference system 104A may receive massive sensor data generated by farm equipment 108-1 to 108-M (and/or farm equipment at other edge sites 102-2 to 102-N) and process it using various techniques to, for instance, make agricultural inferences or generate semantically rich representations that can be processed by downstream components, such as edge computing devices, to generate agricultural inferences. However, growers or other entities that control edge sites 102 may be reluctant or unwilling to share their local data on the cloud.

Accordingly, central agricultural inference system 104A and edge agricultural inference system 104B may generate, and exchange with each other, semantically rich representations such as feature vectors or embeddings (which may or may not be continuous). This may, for instance, allow edge agricultural inference system 104B to perform the “last mile” of processing on these semantically rich representations, using local data that may be protected from the cloud, to generate agricultural inferences. Alternatively, central agricultural inference system 104A may perform the last mile computations using only semantically rich, but difficult for humans to interpret, representations received from the edge, as opposed to raw data that would be more likely to be interpretable by humans.

Referring back to edge agricultural inference system 104B, in some implementations, input data module 114B may be configured to provide various input data (e.g., sensor data, logged data, climate data, etc.) to various downstream components, such as KG navigation module 116B and/or edge ML application module 118B. In some implementations, the vision sensor data may be applied by edge ML application module 118B as input across one or more machine learning models stored in edge database 120B to generate inference(s) about the agricultural field 112 and/or its crops. Edge ML application module 118B may process the inference data in situ at the edge using one or more of the machine learning models stored in database 120B. In some cases, one or more of these machine learning model(s) may be stored and/or applied directly on farm equipment 108, such as edge computing node 108-3 to make predictions about plants of the agricultural field 112.

Various types of machine learning models may be applied by ML application modules 118A/B to perform a variety of different dense prediction tasks. These various machine learning models may include, but are not limited to, various types of recurrent neural networks (RNNs) such as long short-term memory (LSTM) or gated recurrent unit (GRU) networks, transformer networks such as the Bidirectional Encoder Representations from Transformers (BERT) transformer, feed-forward neural networks, convolutional neural networks (CNNs), support vector machines (SVMs), random forests, decision trees, etc. Additionally, various types of machine learning models may be used to generate image embeddings that are applied as input across the various machine learning models.

In this specification, the term “database” and “index” will be used broadly to refer to any collection of data. The data of the database and/or the index does not need to be structured in any particular way and it can be stored on storage devices in one or more geographic locations. Thus, for example, database(s) 115A/B, 117A/B, and/or 120A/B may include multiple collections of data, each of which may be organized and accessed differently.

Edge input data module 114B may be configured to obtain input from various sources, such as client device(s) 106, modular computing device(s) 111, robots 108-1 to 108-M, agricultural vehicle 109, databases of recorded agricultural data (e.g., logs), etc. As indicated by the arrows, edge input data module 114B may provide these input data to edge KG navigation module 116B and/or edge ML application module 118B. Edge agricultural inference system 104B may also include, in communication with edge input data module 114B, an edge database 115B for storing structured and/or unstructured agricultural data, much of which may be private.

Structured agricultural data may include any data that is collected and organized in a consistent and predictable manner. One example is sensor data collected by robots 108-1 to 108-M and/or other agricultural vehicles 109. Another example of structured agricultural data may be data that is input by agricultural personnel into spreadsheets, input forms, etc., such that the data is collected and organized, e.g., by input data module 114, in a consistent and/or predictable manner. For example, growers may maintain logs of how and/or when various management practices (e.g., irrigation, pesticide application, herbicide application, tillage) were performed. Other examples of structured agricultural data (that isn't necessarily private or stored at the edge) may include, for instance, satellite data, climate data from publicly available databases, and so forth.

Unstructured agricultural data may include any data that is collected from sources that are not organized in any consistent or predictable manner. These sources may include, for instance, natural language textual snippets obtained from a variety of sources. As one example, AG client 107 may provide an interface for a user to record spoken utterances. These utterances may be stored as audio recordings, transcribed into text via a speech-to-text (STT) process and then stored, and/or encoded into embeddings and then stored. Other potential sources of natural language textual snippets include, but are not limited to, documents such as contracts and invoices, electronic correspondence (e.g., email, text messaging), periodicals such as newspapers (e.g., reporting floods or other weather events that can impact crops), and so forth. Documents may be obtained, e.g., by edge input data module 114B, from sources such as a client device 106.

Edge agricultural inference system 104B may also include a machine learning model database 120B that includes a variety of different ML models, such as phenotyping ML models. In various implementations, each phenotyping ML model may be trained to generate output 122B that can include, for instance, inferences at various levels of specificity or granularity, semantically rich representations, and so forth.

An edge KG database 117B may store data indicative of a private (and/or local) agricultural KG 117B. In some implementations, private agricultural KG 117B may be stored in a graph database that is local to edge site 102-1. In other implementations, rather than being stored in a database 117B that is local to edge site 102-1, a grower's private agricultural KG 117B may be stored on a “private cloud” that is remote from the edge site 102-1. In some such implementations, access to the grower's private agricultural KG 117B in the private cloud may be limited to the grower and/or individuals selected by the grower.

Edge KG navigation module 116B may be configured with selected aspects of the present disclosure to navigate/traverse through private agricultural KG 117B in response to a variety of different agricultural events and/or queries. Edge KG navigation module 116B may perform this navigation to identify various data sources that are relevant to (e.g., influence, influenced by) the agricultural event and/or responsive to the query. Likewise, edge KG navigation module 116B may identify various ML models (e.g., phenotypic, classifiers, prediction, etc.) and/or ML-based processing pipelines that can be used to process data retrieved from those data sources to generate agricultural inferences and/or semantically rich representations.

During one or more training phases, an edge training module 124B may be configured to train any of the aforementioned ML models (or portions thereof) using ground truth and/or observed phenotypic traits. For example, edge training module 124B may train phenotyping ML models to make phenotypic predictions. Suppose a particular agricultural plot 112 yields 1,000 units of a plant-trait-of-interest. Images of crops in that particular agricultural plot may be captured sometime in the crop cycle prior to harvest. These images may be taken from ground-based vehicles, UAVs, satellites, etc. These images may be processed using a crop yield estimation ML model to predict crop yield. This predicted crop yield may then be compared, e.g., by edge training module 124B, to the ground truth crop yield to determine an error. Based on this error, edge training module 124B may train one or more of the machine learning models in database 120B, e.g., using techniques such as back propagation and gradient descent. In some implementations, local gradients learned by edge training module 124B may be provided to central training module 124A, e.g., as part of a federated learning framework.

As noted previously, in various implementations, central agricultural inference system 104A may include components that are substantially similar to those of edge agricultural inference system 104B. A difference is that the components of central agricultural inference system 104A lack access to private data sources of growers. Consequently, central agricultural inference system 104A may be used to process public data from publicly available data sources (or at least data sources to which the grower has access) identified by a central KG navigation module 116A as being relevant to an agricultural event or query. In particular, central KG navigation module 116A may be configured to navigate/traverse through a public or global agricultural KG 117A in response to a variety of different agricultural events and/or queries, in a manner similar to edge KG navigation module 116B.

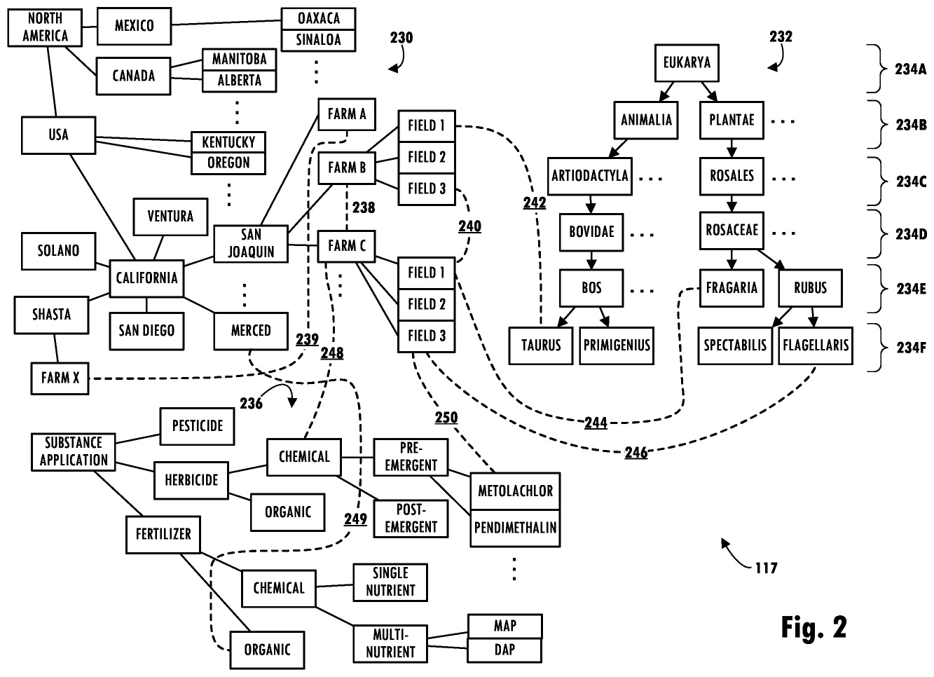

FIG. 2 schematically depicts part of an example agricultural KG 117, in accordance with various implementations. The agricultural KG 117 depicted in FIG. 2 is for illustrative purposes only, is not meant to be comprehensive, and accordingly, should not be viewed as limiting in any way. Each rectangle in FIG. 2 comprises a node of agricultural KG 117 that represents an entity. Each edge represents a relationship between entities represented by the nodes it connects. Agricultural KG 117 may include parts that are local and/or private to individuals or growers, which correspond to private agricultural KG 117B in FIG. 1, as well as other parts that are generic across growers, which correspond to public agricultural KG 117A in FIG. 1.

In this example, agricultural KG 117 includes a first portion indicated generally at 230 that represents locations, a second portion indicated generally at 232 that represents organisms, and a third portion indicated generally at 236 that represents agricultural tasks, in this case, application of substances such as pesticides, herbicides, and fertilizers. It should be understood that agricultural KG 117 may include other portions that represent other entities relevant to agriculture, such as agricultural equipment (e.g., robots, tractors, threshers, sprayers, cisterns), robots (e.g., 108-1 to 108-M), climate events (e.g., hurricanes, floods, draughts), stewardship events (e.g., instance of applied tillage, applied crop rotation), and so forth.

First portion 230 of agricultural KG 117 includes, at top left, a node representing North America. Although not shown, agricultural KG 117 may or may not include nodes representing the other continents of Earth. The North America node is connected to nodes representing Mexico, Canada, and the United States (USA). Each of those country nodes is, in turn, connected to nodes representing their various states. For instance, the USA node is connected to nodes representing California, Kentucky, and Oregon (and presumably nodes representing other states and territories of the USA). The California node is connected to nodes representing various California counties, such as Ventura, Solano, Shasta, San Diego, Merced, and San Joaquin, to name a few. Other states' nodes may or may not be similarly connected to county nodes.

The San Joaquin County node is connected to some number of nodes representing some number of farms or other agricultural centers in San Joaquin County. In FIG. 2, for instance, the San Joaquin node is connected to nodes representing Farm A, Farm B, Farm C, and so on. Each of these farm nodes may, in turn, be connected to node(s) representing individual agricultural fields or plots. For example, Farm B's node is connected to nodes representing fields 1-3. Similarly, Farm C's node is connected to nodes representing fields 1-3. As indicated by the various ellipses depicted in FIG. 2, it should be apparent that the various entities represented by the visible nodes are not intended to be limiting. Nodes and/or edges representing continents, countries, states, counties, and other regions (or the relationships therebetween) that are likely shared by multiple growers, will typically be part of public agricultural KG 117A. Nodes and/or edges representing individual farms and fields (or the relationships therebetween), on the other hand, may be part of public agricultural KG 117A or private agricultural KG 117B, depending on the preferences of the agricultural entit(ies) that control those farms/fields.

Various nodes of first portion 230 may be linked to each other in ways other than the solid lines depicted in FIG. 2, such as ad hoc relationships. For instance, nodes representing Farms B and C in San Joaquin County of California are connected by dashed edge 238 to indicate that these farms have a relationship beyond being located in the same county. For instance, edge 238 may represent the fact that these farms are proximate with each other, even sharing a border. Another edge 239 connecting Farm A in San Joaquin County with a Farm X in Shasta County may represent, for example, the fact that these two farms have been designated as similar or identical Agro Ecological Zones (“AEZs,” e.g., as provided by the Food and Agricultural Organization of the United Nations). Alternatively, nodes representing farms (or counties, or states, or individual fields/plots) having the same AEZ may be connected to a separate node representing that shared AEZ.

Second portion 232 of agricultural KG 117 comprises a phenotypic taxonomy of nodes representing a taxonomic hierarchy of organisms. The taxonomic hierarchy, and hence, phenotypic taxonomy of nodes (which will also be referred to herein with the reference numeral 232), is organized into multiple levels or ranks 234A-F. In this example, there are six ranks: 234A corresponding to domain; 234B corresponding to kingdom; 234C corresponding to order; 234D corresponding to family; 234E corresponding to genus, and 234F corresponding to species. However, this is not intended to be limiting, and other ranks, such as phylum, class, or various subcategories of various ranks, may also be included. The nodes of phenotypic taxonomy of nodes 232 may provide access to phenotyping ML models, e.g., by linking or pointing to files or other data structures containing the weights of these phenotyping ML models. The nodes/edges of second portion 232 would typically be part of public agricultural KG 117A, although it is possible for an individual grower to maintain their own private ML models and/or ML processing pipelines in connection with their own private agricultural KG 117B.

Third portion 236 of agricultural KG 117 represents entities associated with the application of substances to agricultural areas. In FIG. 2 these substances may include pesticides, herbicides, and fertilizers, as indicated by the three nodes, but this is not intended to be limiting. FIG. 2 also demonstrates that some subcategories or subclasses of these substances can be represented by additional nodes. For example, the node representing herbicide is connected to nodes representing chemical (or inorganic) herbicides and organic herbicides. The node representing chemical (or inorganic) herbicides is connected to nodes representing pre-emergent herbicides and post-emergent herbicides. The node representing pre-emergent herbicides is connected to nodes representing various types or classes of pre-emergent herbicides, such as metolachlor and pendimethalin, to name a few. The fertilizer node similarly is connected to levels of nodes separating fertilizers into chemical versus organic, as well as single nutrient versus multi-nutrient. And the multi-nutrient fertilizer node is connected to nodes representing monoammonium phosphate (MAP) and diammonium phosphate (DAP).

Other types of ad hoc relationships may be defined as part of agricultural KG 117, in addition to those described previously. For instance, an edge 240 is defined between Field 3 of Farm B in San Joaquin County and Field 1 of Farm C in the same county. This edge may specify, for instance, that these fields share a border, are adjacent, and/or are within a predetermined distance of each other. This may be consequential, for instance, because pests, diseases, weeds, or other phenomena that impact one of these fields may also impact (or be likely to impact) the other. Alternatively, nodes representing fields may be connected to each other with edges, where the edges themselves represent distances between the fields. Another edge 242 is defined between the node representing Field 1 of Farm B in San Joaquin County and a node representing the Taurus species (cattle) of phenotypic taxonomy of nodes 232. This may indicate that cattle are being, or have been, raised or allowed to graze in Field 1. If the grower that controls Farm B in San Joaquin Country wishes, they can make the edge 242 part of their private agricultural KG 117B. The same is true for other edges depicted in FIG. 2, such as the edges indicated at 244, 246, 248, 250, etc. For example, local copies of the nodes connected by those edges may be maintained as part of the private agricultural KG 117B, in addition to the edges connecting them.

Edge 244 connects the node representing Field 1 of Farm C in San Joaquin County and the node representing the Fragaria genus; this may represent an ad hoc relationship of strawberries and/or other species of that genus being grown, or having been grown, in that field. Yet another edge 246 is defined between the node representing Field 3 of Farm C in San Joaquin County and the node representing the flagellaris species of the Rubus genus. This may indicate that the northern dewberry is being, or has been, grown in Field 3. Yet another edge 248 is defined between the node representing Farm C of San Joaquin County and the node representing chemical herbicides. This may indicate that chemical herbicides, not organic, have been, are being, and/or will be applied to all fields of Farm C. Yet another edge 250 indicates that the pre-emergent metolachlor has been, is being, or will be applied to Field 3 of Farm C in San Joaquin County.

The ad hoc relationships represented by edges 238-250 in FIG. 2 may be created in various ways. In some implementations, they may be created manually, e.g., by operating a graphical user interface (GUI) to draw edges between the various nodes. Additionally or alternatively, these relationships may be defined using database records/fields. In some implementations, these edges may be created based on natural language input. For instance, a grower of Farm C in San Joaquin County may utter the statement, “I'm only going to use chemical herbicides in Field 3.” This utterance may be speech-to-text (STT) processed to generate text, which may then be analyzed using natural language processing. The result of the natural language processing may be used to generate edge 248. Other sources of natural language may include, for instance, contracts, correspondence, regulations, etc. For example, if a regulation is issued that requires all strawberry farms in Merced County, California to use only organic fertilizers, that regulation may be natural language processed to generate an edge 249 between the node representing organic fertilizer and the node representing Merced County.

When nodes and/or edges are created, they may be designated for inclusion in public agricultural KG 117A and/or in private agricultural KG 117B. For example, when drawing an edge between nodes, a user may select a menu associated with the edge that allows the user to designate the edge as private or public. As another example, when providing a natural language utterance, the speaker can specify that what they're saying should be kept private, and hence, within their own private agricultural KG 117B. For example, the grower of Farm C in San Joaquin County may utter the statement, “I've applied two different fungicides in Field 3 this year, and I want that kept private.”

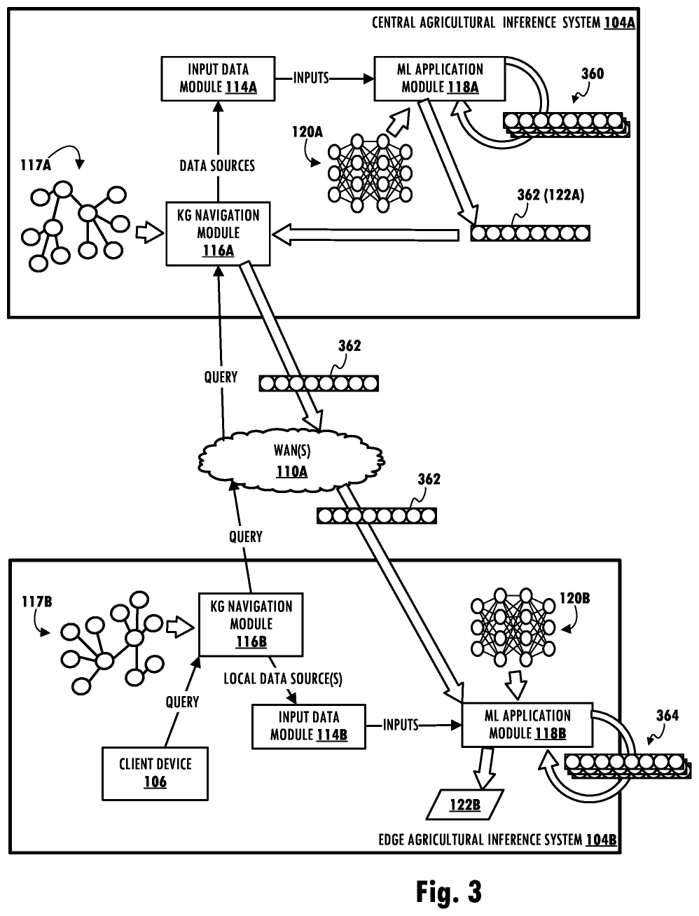

FIG. 3 schematically depicts an example of how data may be processed using techniques described herein. Starting at bottom left, a user (not depicted) may operate a client device 106 to input a query at and/or to edge agricultural inference system 104B. This query may be, for instance, a question about how the user should manage a particular field. The query may be processed by edge KG navigation module 116B, which may navigate and/or traverse private agricultural KG 117B to identify various local/private data sources, e.g., stored locally or in a private cloud accessible to the user. These local/private data sources may be provided to input data module 114B. Input data module 114B may then provide these inputs to edge ML application module 118B.

Edge ML application module 118B may be configured to process the inputs using one or more ML models 120B that are available at the edge. In some implementations, edge ML application module 118B may also be configured to obtain, as needed, other ML models, e.g., from central database 120A, that are not otherwise available at the edge. In various implementations, these ML model(s) 120B may include sequence-to-sequence models, such as transformer network(s), that are usable by ML application module 118B to encode the inputs received from input data module 114B into one or more private or local embeddings 364. In some implementations, each private embedding 364 may represent data obtained from a respective local data source (identified by edge KG navigation module 116B previously). In some implementations, an aggregate private embedding (not depicted) may be generated from a plurality of different private embeddings 364 generated from private data retrieved from private data sources, e.g., using techniques such as concatenation, addition, averaging, sequence-to-sequence ML processing, etc.

Meanwhile, edge KG navigation module 116B may also pass data indicative of the query through one or more WANs 110A to central agricultural inference system 104A. This data indicative of the query may include, for instance, speech recognition output of a spoken query, an embedding generated from the query (e.g., using techniques such as Word2Vec), an intent (and slot values, if applicable) determined by semantically processing the query, etc.

At central agricultural inference system 104A, central KG navigation module 116A may perform operations similar to those performed by edge KG navigation module 116B to navigate and/or traverse through public agricultural KG 117A to identify global and/or public data sources that are related to the query. Similar to the case with edge agricultural inference system 104B, these public data sources may be accessed by central input data module 114A to retrieve inputs. These inputs in turn may be provided to central ML application module 118A, which may process the inputs using one or more global or public ML models 120A. Based on this processing, central ML application module 118A may generate one or more public embeddings 360. As was the case with private embeddings 364, each of public embeddings 360 may encode data retrieved from a distinct public data source.

In some implementations, the public embeddings 360 may be used to generate an aggregate public embedding 362, e.g., using techniques such as concatenation, addition, averaging, etc. Aggregate public embedding 362 may correspond to output 122B in FIG. 1. In other implementations, the aggregate public embedding 362 may be generated by processing the plurality of different public embeddings 360 using a sequence-to-sequence machine learning model, such as a transformer network, RNN, LSTM, GRU, etc.

In some implementations, and as is depicted in FIG. 3, aggregate public embedding 362 may be passed by central agricultural inference system 104A to edge agricultural inference system 104B. Edge ML application module 118B may then process aggregate public embedding 362, in a sequence along with private embeddings 364 and/or an aggregate private embedding (if available, not depicted in FIG. 3), to generate output 122B. Output 122B may include one or more agricultural inferences that are responsive to the original query, e.g., in textual form or as a semantically rich embedding. In some implementations, this output may include a semantically rich embedding which may in turn be processed using downstream model(s) to generate output text.

In implementations in which a transformer network is employed as the machine learning model to process private embeddings 364 and aggregate public embedding 362, it may not matter if all relevant data points are included, or the order in which the transformer network processes the inputs. A transformer network may be trained on a large corpus of multi-modal, structured and unstructured agricultural data, such that the transformer network is capable of making predictions based on sequences of input data having varying lengths. The inferences 122B drawn from whatever data is retrieved may still be at least somewhat accurate, if less so than where more data sources are available.

In some implementations, rather than navigating private agricultural KG 117B for relevant private data sources, all or part of private agricultural KG 117B may be encoded into a semantically rich embedding, and this embedding may in turn be processed by ML application module 118B (or 118A in some cases) to generate output 122B. For example, each piece of metadata contained in private agricultural KG 117B may be tokenized and packed into an input sequence, along with corresponding values of the metadata. Natural language processing techniques such as Word2Vec and/or transformer networks may be used to encode individual pieces of metadata and corresponding values. In some implementations, these encodings may be associated with nodes and/or edges of private agricultural KG 117B. Consequently, a machine learning model configured for processing graph input, such as a graph neural network (GNN), may be used to generate a schema-aware, semantically rich field-level embedding of private agricultural KG 117B and the encodings of its individual nodes.

In some implementations, this schema-aware, semantically rich field-level embedding of private agricultural KG 117B may be processed, e.g., by edge KG navigation module 116B or central KG navigation module 116A. Based on this processing, various ML models and/or ML processing pipelines may be identified and applied, e.g., to the schema-aware, semantically right field-level embedding of private agricultural KG 117B and any other relevant data sources identified from public agricultural KG 117A, to generate output 122B.

As an example, suppose a user submits a query, “can you predict my strawberry yield this season in Field A?” This may trigger the process depicted in FIG. 3. At central agricultural inference system 104A, relevant public data sources are consulted to retrieve public data that is relevant to the query. In this case, these public data retrieved by central input data module 114A may include, but are not limited to, weather data that is applicable to Field A, aggregate yield information from surrounding fields/farms (if available), satellite imagery that depicts Field A, inferences drawn from that satellite imagery (“remote sensing”) about Field A using machine learning (e.g., crop health, soil composition, etc.), yields of similar fields, precipitation, market conditions, etc. These public data may be processed, e.g., to generate a sequence of public embeddings 360 and/or one or more aggregate public embeddings 362. Embeddings 360/362 may then be passed from central agricultural inference system 104A to edge agricultural inference system 104B.

Edge input data module 114B meanwhile may retrieve private data from private data sources (locally at the edge or within a private cloud). These private data may include, but are not limited to, the grower's historical yields (in the same field and/or in different fields), the grower's personal agricultural management practices (e.g., how much/how frequently chemicals such as herbicides, fungicides, fertilizers, etc. are applied, tillage practices, cover crop rotations, type of varietal planted, etc.), and so forth. From this private data, edge ML application module 118B may generate one or more private embeddings 364 (or an aggregate private embedding. where applicable). These private embeddings 364 and public embedding(s) 360/362 may then be processed by edge ML application module 118B, e.g., using a sequence-to-sequence ML model such as a transformer network, to generate a predicted crop yield 122B.

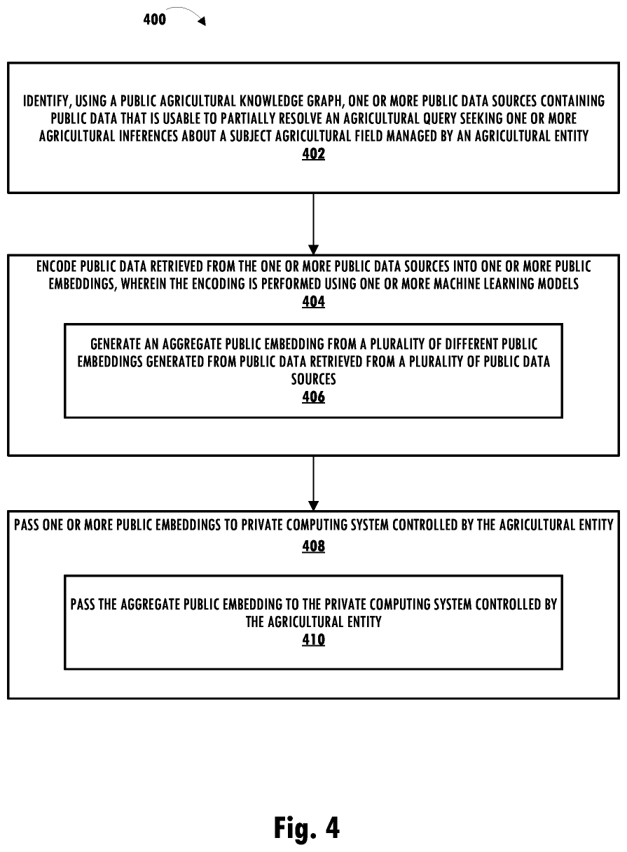

FIG. 4 illustrates a flowchart of an example method 400 for practicing selected aspects of the present disclosure. The operations of FIG. 4 can be performed by one or more processors, such as one or more processors of central agricultural inference system 104A described herein. For convenience, operations of method 400 are described as being performed by a system configured with selected aspects of the present disclosure. Other implementations may include additional operations than those illustrated in FIG. 4, may perform step(s) of FIG. 4 in a different order and/or in parallel, and/or may omit one or more of the operations of FIG. 4.

At block 402, the system, e.g., by way of central KG navigation module 116A, may identify, using public agricultural KG 117A, one or more public data sources containing public data that is usable to respond to, e.g., by partially or fully resolving, an agricultural query seeking one or more agricultural inferences (e.g., crop yield, crop health, P and K removal map, etc.) about a subject agricultural field managed by an agricultural entity. For example, the query may be resolved to an intent using natural language processing and/or semantic analysis. That intent may be used to determine one or more data points (e.g., slot values) that are required to fulfill the intent. To the extent these data points are available from public agricultural KG 117A, the data sources of those data points may be identified and used to retrieve the data points.

At block 404, the system, e.g., by way of central ML application module 118A, may encode public data retrieved from the one or more public data sources into one or more public embeddings (e.g., 360). As noted previously, this encoding may be performed using one or more machine learning models, such as a transformer network trained on agricultural data. For example, metadata and associated values may be tokenized into a sequence and processed using the transformer network. In some implementations, at block 406, multiple different public embeddings (360) may be used to generate an aggregate public embedding (e.g., 362), e.g., via techniques such as concatenation, averaging, addition, or by being processed as a sequence using a sequence-to-sequence machine learning model, such as a transformer network,

At block 408, the system, e.g., by way of central ML application module 118A, may pass the one or more public embeddings (360) to a private computing system controlled by the agricultural entity. If applicable, this may include passing the aggregate public embedding to the private computing system at block 410. This private computing system may be, for instance, edge agricultural inference system 104B, and/or may be a private cloud infrastructure controlled by the agricultural entity.

The passing of blocks 408-410 may cause the private computing system to: identify, using a private agricultural knowledge graph accessible to the private computing system, one or more private data sources containing private data that is usable to partially resolve the agricultural query; and encode private data retrieved from the one or more private data sources into one or more private embeddings. The one or more public embeddings and one or more private embeddings ultimately may be processed using one or more ML models, such as one or more of the transformer networks described herein, to generate the one or more agricultural inferences (122B) about the subject agricultural field.

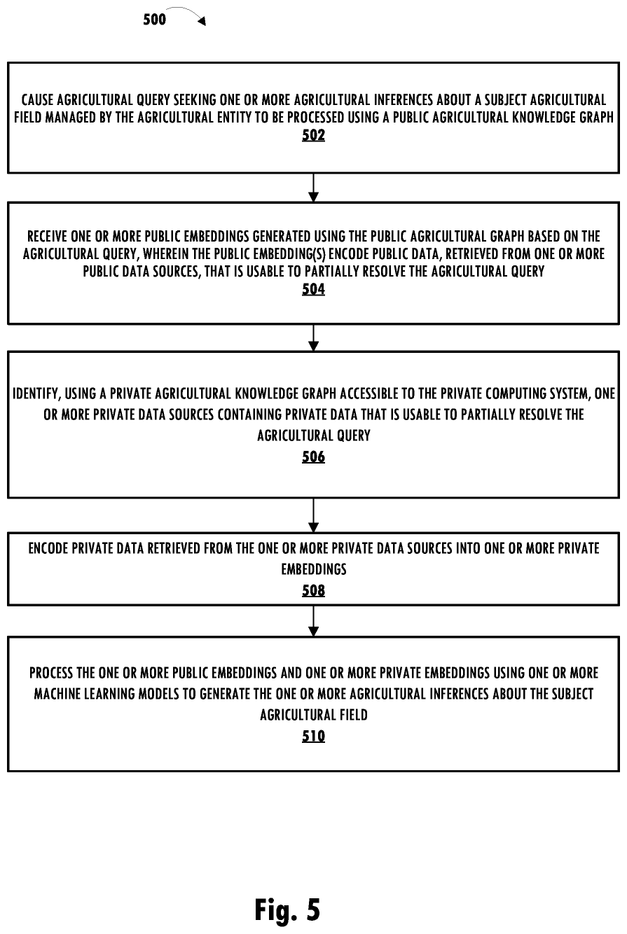

FIG. 5 illustrates a flowchart of an example method 500 for practicing selected aspects of the present disclosure. The operations of FIG. 5 can be performed by one or more processors, such as one or more processors of the various computing devices/systems described herein, such as edge agricultural inference system 104B and/or by one or more processors providing a private cloud in which private data is accessible. For convenience, operations of method 500 are described as being performed by a system configured with selected aspects of the present disclosure. Other implementations may include additional operations than those illustrated in FIG. 5, may perform step(s) of FIG. 5 in a different order and/or in parallel, and/or may omit one or more of the operations of FIG. 5.

At block 502, the system, e.g., by way of edge KG navigation module 116B or edge ML application module 118B, may cause an agricultural query seeking one or more agricultural inferences about a subject agricultural field managed by the agricultural entity to be processed using a global or public agricultural knowledge graph (e.g., 117A). For example, edge KG navigation module 116B may provide the query and/or data indicative of the query (e.g., an encoded embedding of the query, an intent determined from the query) to central agricultural inference system 104A over one or more WANs. In some implementations, the agricultural query may be provided manually as input by a user, e.g., using spoken or typed natural language input. In other implementations, the agricultural query may be generated and provided automatically, e.g., in response to an agricultural event. Agricultural events can take a variety different forms, including but not limited to flooding, drought, fire, an agricultural worker selecting a field in a field browsing computer application, an agricultural worker being detected in a particular field, a pest infestation being detected (directly based on observation or indirectly based on application of pesticide or fungicide) in a nearby field (which may impact a field of interest), and so forth.

At block 504, the system, e.g., by way of edge ML application module 118B, may receive one or more public embeddings (e.g., 360) or aggregated embeddings (e.g., 362) generated using the public agricultural graph (e.g., 117A) based on the agricultural query. As explained herein, the one or more public embeddings may encode public data, retrieved from one or more public data sources, that is usable to fully or partially resolve the agricultural query. For instance, the public embeddings may represent information obtained from satellite imagery, weather databases, nearby farms, similar farms, etc.

At block 506, the system, e.g., by way of edge KG navigation module 116B, may identify, using a private agricultural knowledge graph (e.g., 117B) accessible to the private computing system (e.g., 104B), one or more private data sources containing private data that is usable to fully or partially resolve the agricultural query. At block 508, the system, e.g., by way of edge ML application module 118B, may encode private data retrieved from the one or more private data sources into one or more private embeddings (e.g., 364). These private embeddings may represent private or sensitive information pertaining to, for instance, agricultural management practices, varietals of crops grown, chemical applications, etc.

At block 510, the system, e.g., by way of edge ML application module 118B, may process the one or more public embeddings and one or more private embeddings using one or more machine learning models, such as a sequence-to-sequence model (e.g., a transformer network), to generate the one or more agricultural inferences (e.g., 120B) about the subject agricultural field. The one or more agricultural inferences may then be used in various ways. In some implementations, they may be presented to a user, e.g., the user who initially submitted the agricultural query, as visual and/or audible output. For example, a report may be generated that includes the requested information (e.g., predicted crop yield, P and K removal map, heat map showing pest infestation presence/magnitude, heat map showing plant health/hydration/bounty, etc.).

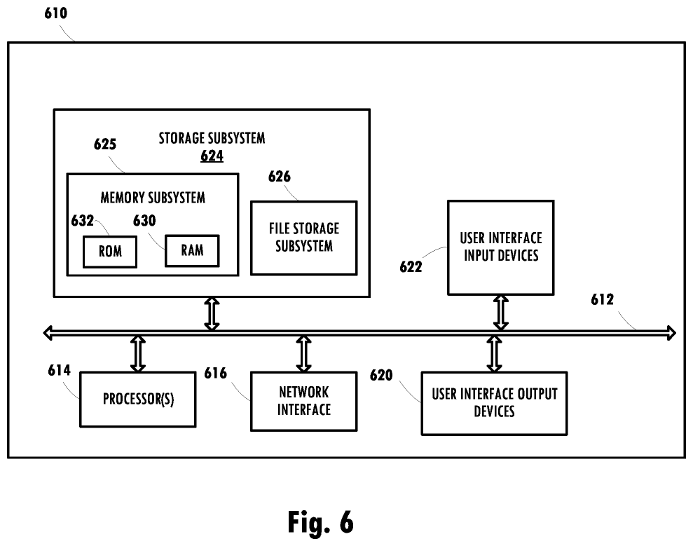

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In some implementations in which computing device 610 takes the form of a HMD or smart glasses, a pose of a user's eyes may be tracked for use, e.g., alone or in combination with other stimuli (e.g., blinking, pressing a button, etc.), as user input. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, one or more displays forming part of a HMD, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of methods 400-500 described herein, as well as to implement various components depicted in FIGS. 1-3.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
identifying, using a public agricultural knowledge graph, one or more public data sources containing public data that is usable to respond to an agricultural query seeking one or more agricultural inferences about a subject agricultural field managed by an agricultural entity;
encoding public data retrieved from the one or more public data sources into one or more public embeddings, wherein the encoding is performed using one or more machine learning models;
passing the one or more public embeddings to a private computing system controlled by the agricultural entity, wherein the passing causes the private computing system to:
identify, using a private agricultural knowledge graph accessible to the private computing system, one or more private data sources containing private data that is usable to respond to the agricultural query; and
encode private data retrieved from the one or more private data sources into one or more private embeddings;
wherein the one or more public embeddings and one or more private embeddings are processed using one or more of the machine learning models to generate the one or more agricultural inferences about the subject agricultural field.

2. The method of claim 1, wherein the passing causes the private computing system to process the public and private embeddings using one or more of the machine learning models to generate the one or more agricultural inferences about the subject agricultural field.

3. The method of claim 1, wherein one or more of the machine learning models comprises a transformer network.

4. The method of claim 1, wherein the encoding comprises generating an aggregate public embedding from a plurality of different public embeddings generated from public data retrieved from a plurality of public data sources;
wherein the passing comprises passing the aggregate public embedding to the private computing system controlled by the agricultural entity.

5. The method of claim 4, wherein the aggregate public embedding is generated by processing the plurality of different public embeddings using a sequence-to-sequence machine learning model.

6. The method of claim 1, wherein the private computing system comprises one or more computing devices that collectively provide a private cloud computing environment to the agricultural entity.

7. The method of claim 1, wherein the private computing system comprises one or more edge computing devices operated by the agricultural entity.

8. The method of claim 1, wherein the public data includes data about one or more other agricultural fields that are proximate to the subject agricultural field.

9. The method of claim 1, wherein the public data includes satellite imagery that depicts the subject agricultural field.

10. The method of claim 9, wherein the public data includes inferences generated from processing the satellite imagery using one or more machine learning models.

11. A method implemented using one or more processors of a private computing system controlled by an agricultural entity, the method comprising:
causing an agricultural query seeking one or more agricultural inferences about a subject agricultural field managed by the agricultural entity to be processed using a public agricultural knowledge graph;
receiving one or more public embeddings generated using the public agricultural graph based on the agricultural query, wherein the one or more public embeddings encode public data, retrieved from one or more public data sources, that is usable to respond to the agricultural query;
identifying, using a private agricultural knowledge graph accessible to the private computing system, one or more private data sources containing private data that is usable to respond to the agricultural query;
encoding private data retrieved from the one or more private data sources into one or more private embeddings; and
processing the one or more public embeddings and one or more private embeddings using one or more machine learning models to generate the one or more agricultural inferences about the subject agricultural field.

12. The method of claim 11, wherein one or more of the machine learning models comprises a transformer network.

13. The method of claim 11, wherein the private computing system comprises one or more computing devices that collectively provide a private cloud computing environment to the agricultural entity.

14. The method of claim 11, wherein the private computing system comprises one or more edge computing devices operated by the agricultural entity.

15. The method of claim 11, wherein the processing includes processing the one or more public embeddings and the one or more private embeddings using a sequence-to-sequence machine learning model.

16. The method of claim 11, wherein one or more of the private data sources includes one or more documents accessible to the agricultural entity.

17. The method of claim 11, wherein one or more of the private data sources includes a database of agricultural operations performed in the subject agricultural field.

18. The method of claim 11, wherein one or more of the private data sources includes one or more historical crop yields of the subject agricultural field.

19. A system comprising one or more processors and memory storing instructions that, in response to execution by the one or more processors, cause the one or more processors to:
cause an agricultural query seeking one or more agricultural inferences about a subject agricultural field managed by an agricultural entity to be processed using a public agricultural knowledge graph;
receive one or more public embeddings generated using the public agricultural graph based on the agricultural query, wherein the one or more public embeddings encode public data, retrieved from one or more public data sources, that is usable to respond to the agricultural query;
identify, using a private agricultural knowledge graph accessible to the private computing system, one or more private data sources containing private data that is usable to respond to the agricultural query;
encode private data retrieved from the one or more private data sources into one or more private embeddings; and
process the one or more public embeddings and one or more private embeddings using one or more machine learning models to generate the one or more agricultural inferences about the subject agricultural field.

20. The system of claim 19, The method of claim 11, wherein one or more of the machine learning models comprises a transformer network.
